(19) United States
(12) Patent Application Publication
(10) Pub. No.: US 2006/0168419 A1
(43) Pub. Date: Jul. 27, 2006

(54) Method for updating entries of address conversion buffers in a multi-processor computer system

(75) Inventor: Jurgen Gross, Rosenheim (DE)

Correspondence Address: COHEN, PONTANI, LIEBERMAN & PAVANE;Suite 1210, 551 Fifth Avenue, New York, NY, 10176, US

(73) Assignee: Fujitsu Siemens Computers GmbH, Munchen (DE)

(21) Appl. No.: 11/315,055

(22) Filed: Dec. 22, 2005

(30) Foreign Application Priority Data
Dec. 23, 2004 (DE) 10 2004 062 287.6

(51) Int. Cl. G06F 12/10

(52) U.S. Cl. 711/170; 711/202

(57) ABSTRACT

A method for the updating of entries of address conversion buffers in a multi-processor computer system, wherein each processor exhibits an address conversion buffer and wherein a page-by-page virtually addressable main memory is provided. A table is provided in the main memory, into which an entry is made for each memory page and each processor as to whether an entry (3) for this memory page is present in the address conversion buffer of the corresponding processor. In the event of a change to the address allocation of a memory page, a message is sent exclusively to such processors that comprise an entry for the corresponding memory page in their address conversion buffer. A multi-processor computer system is disclosed which is suitable for carrying out the method.

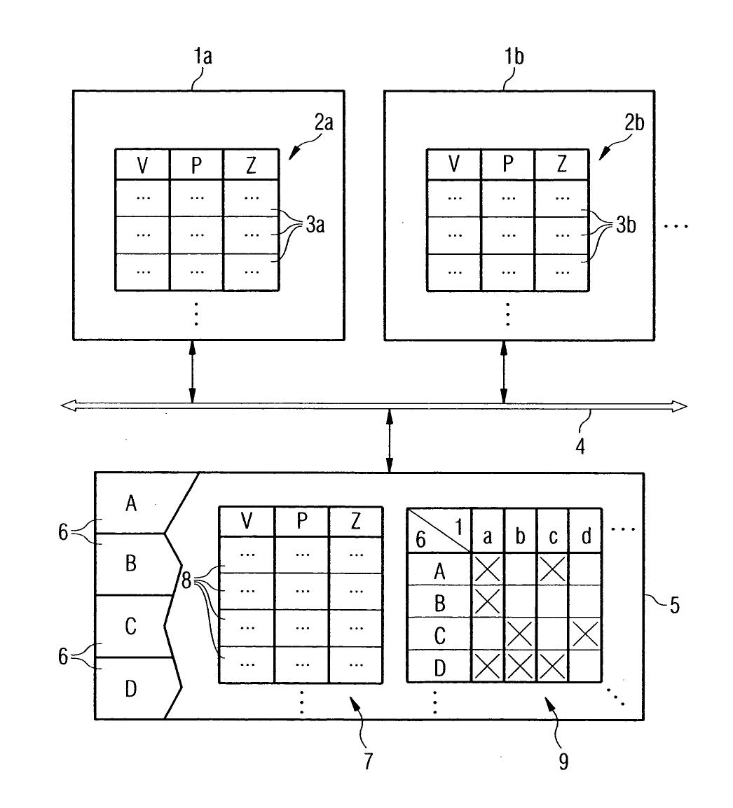

### RELATED APPLICATIONS

This patent application claims the priority of German patent application 10 2004 062 287.6 filed Dec. 23, 2004, the disclosure content of which is hereby incorporated by reference.

### FIELD OF THE INVENTION

The invention relates to a method for the synchronisation of entries of address conversion buffers in a multi-processor computer system. The invention further relates to a multi-processor computer system with a page-by-page virtually addressable main memory, with which every processor of the multi-processor computer system exhibits an address conversion buffer.

### BACKGROUND OF THE INVENTION

Computer systems usually use a virtual memory management system, with which user programs and processes do not directly address memory cells of the available volatile memory (main memory) by way of their physical address. Instead, an individual address space, consisting of a linear sequence of addresses, is provided for each individual process, which is referred to as the logical or virtual address space. When a memory is accessed, the operating system converts the virtual address under which the user program manages a memory cell into the actual physical address of the corresponding memory cell of the main memory.

One advantage of this virtual addressing is that programs can be provided with a memory space which extends beyond the size of the main memory. Regardless of the structure of the main memory, the virtual address space always has the same simple and linear structure. In addition, thanks to the virtual memory management, address spaces of different processes can be easily separated from one another, and in this way sensitive data can be protected from unentitled access via other processes.

To convert a virtual address into a physical address, for example, an address conversion table deposited in the main memory is used. For this purpose, both the virtual address space and the main memory can be subdivided into blocks of specified size, which are also designated as pages. An address then consists in each case of an address part, the page address, which indicates a specific page, and an address part, the offset address, which described a byte (or another smallest addressable memory unit) within the page. In this case, the physical address of an allocated page in the main memory is then deposited in the address conversion table to a virtual address of a page in the virtual address space. When the conversion takes place, the physical page address is taken from the address conversion table on the basis of the virtual page address. The offset address is the same with the virtual and the physical address. In addition to such a single-stage allocation with the aid of a table, several different further embodiments are known, such as a multi-stage allocation with two tables, which are frequently designated as segment and page tables. In addition to the address allocation, the tables can contain additional information, e.g. about the process to which the corresponding page is allocated, its owner, access rights, and status information.

A disadvantage with this method of address conversion is that every memory access is associated with one or more accesses in the address conversion table, which prolongs the access times. In order to accelerate the address conversion, therefore, a faster intermediate memory (cache memory) is frequently used for (at least some) entries in the address conversion table, which is referred to as the address conversion buffer or translocation look-aside buffer or Blaauw box. Modern processors typically support virtual memory management in that they themselves provide such an address conversion buffer, which, for example, can be designed as an associative memory or as a set-associative memory.

As with every fast buffer or cache memory, care must be taken to ensure that the data of the buffer, in this case the entries of the address conversion buffer, and the original data, i.e. in this case the entries of the address conversion table, are kept constant. It is usual for the operating system to take over the updating or synchronisation of the entries. This task becomes problematic if several processors are present in a computer system, in each case with their own address conversion buffer, which use a common main memory. Any change to an entry in the address conversion table in the main memory or to an entry in one of the address conversion memories of a processor, will, according to the state of the art, be notified to every other processor, so that this can be adapted accordingly to an entry which may already be present in its address conversion buffer, or can be removed. The data presence which accordingly results on the bus system by which the processors and the main memory are connected to one another can exert a negative effect on the performance of the computer.

Various different methods are used according to the prior art in order to keep this influence as low as possible. On the one hand, for example, the principle is known of processes being allocated to a processor in an unalterable manner at their start. As a result of the fact that changing a process to another processor is prevented, a thorough updating of the access rights in the additional information of entries in the address conversion table is prevented. A disadvantage, however, is that an optimum operational distribution among all the processors present in the system is interfered with by the fixed allocation.

On the other hand, the principle is known that allocations of virtual memory pages to physical memory pages cannot be deleted if it is not foreseen that access will be made to the memory page concerned. If at a later time it is intended that an access should in fact be effected, the allocation pertains as before, without the need for an update of the entries in the address conversion buffer and address conversion table during the deleting and re-establishment of the allocation. The disadvantage of this method is that on average more main memory is occupied by the individual processes than is necessary.

### SUMMARY OF THE INVENTION

One object of the present invention is to provide a method for the updating of entries of address conversion buffers in a multi-processor computer system, wherein the updating procedure exerts the smallest possible negative influence on the performance and efficiency of the computer system.

Another object is to provide a multi-processor computer system with a page-by-page virtually addressable main memory, which is suitable for carrying out this method.

These and other objects are attained in accordance with one aspect of the present invention directed to a method for updating entries of address conversion buffers in a multi-processor computer system, wherein each processor exhibits an address conversion buffer and wherein a main memory which is addressed virtually page by page, is provided for. The method comprises the steps of providing entries of the address conversion buffer comprise a virtual address (V) of a memory page, a physical address (P) of the memory page, and additional information (Z) relating to the memory page; providing a table in the main memory into which an entry is made for each memory page and each processor as to whether an entry is present for this memory page in the address conversion buffer of the corresponding processor; and in the event of a change in the additional information (Z) or a change or a new deposition or a deletion of the allocation of a physical address (P) to a virtual address (V) of a memory page, sending a message exclusively to such processors that comprise an entry for the corresponding memory page in their address conversion buffer.

Another aspect of the present invention is directed to a multi-processor computer system with a page-by-page virtually addressable main memory, wherein each processor of the multi-processor computer system exhibits an address conversion buffer, wherein entries of the address conversion buffer comprise a virtual address (V) of a memory page, a physical address (P) of the memory page, and additional information (Z) relating to the memory page; a table provided in the main memory, in which an entry is made for each memory page and each processor as to whether an entry for this memory page is present in the address conversion buffer of the corresponding processor; and an operating system which is adapted such that, in the event of a change to the additional information (Z) or a change or new deposition or deletion of the allocation of a physical address (P) to a virtual address (V) of a memory page, a message is sent exclusively to such processors that comprise an entry for the corresponding memory page in their address conversion buffer.

Because a message relating to changes or new depositions or deletions of the allocation between a physical address and a virtual address of a memory page or its additional information is only forwarded to such processors of which the address conversion buffers also exhibit a corresponding entry relating to the memory page, unnecessary data presence is prevented on the bus system which connects the processors and the main memories. In order for this message to be sent selectively, according to the invention a table is provided in the main memory, in which is stored information about to which memory pages entries in the address conversion buffers of the various different processors are being conducted.

### BRIEF DESCRIPTION OF THE SINGLE DRAWING

The drawing shows an embodiment of a multi-processor computer system according to the invention.

### DETAILED DESCRIPTION OF THE SINGLE DRAWING

The multi-processor computer system in the FIGURE includes several processors, of which in this case two processors 1a and 1b are represented. The processors in each case exhibit an address conversion buffer (2a, 2b), with entries (3a, 3b). Each entry contains a physical address P, a virtual address V, and additional information Z. The processors 1 are connected via a bus system 4 to a main memory 5. The main memory 5 exhibits a plurality of memory pages 6, of which, by way of example, the memory pages 6A, 6B, 6C and 6D are shown. The main memory 5 further exhibits an address conversion table 7 with entries 8, in which likewise in each case a physical address P, a virtual address V, and additional information Z are deposited. In addition, a table 9 is provided in the main memory 5, the lines of which in each case represent a memory page 6 and the columns of which represent a processor 1.

Of the multi-processor computer system, represented in the FIGURE as features according to the invention are only the processors, the bus system, and the main memory 5. It is understood that the multi-processor computer system can include other components which are not shown here. The showing of two processors 1a, 1b, is also to be understood as being only an example. The invention is not restricted to this number, and with multi-processor computer systems in particular it has proved to be advantageous with a larger number of processors.

As is usual with computer systems with a virtual memory addressing system, the main memory 5 is subdivided into a plurality of memory pages 6. The memory pages 6 have a specified size, whereby 4 or 8 kBytes are a usual value for the size. The physical address P and the virtual address V of a memory cell of the main memory 5 are then subdivided into a page address, which indicates a specific page, and an offset address, which describes a byte within a page. The offset address is the same for P and for V, while the page address is converted at every memory access. This conversion is carried out with the aid of the address conversion table 7, of which the entries 8 to each virtual address V of a page contain its physical address V. In addition, the entries 8 accommodate the additional information Z, in which, for example, access rights or status information are deposited. Access rights indicate which process or user may have access to a specific memory page. Status information can be information as to whether data contents of this memory page in the main memory are current, or whether there are more current data contents for this memory page, already altered, in a cache memory (not shown here). The structure of the virtual memory management realised in this embodiment with the (single-stage) address conversion table 7 is to be understood as being only an example. The invention is independent of the structure of the virtual memory management, and can be transferred to any desired arrangements of the virtual memory management.

In order for the address conversion necessary at every memory access to be able to be carried out with as little loss of time as possible, the processors 1a and 1b, as is known from the prior art, exhibit fast address conversion buffers 2a and 2b, designed as associative memories. The entries 3a and 3b of the address conversion buffers are copies of selected entries 8 of the address conversion table 7. In this context, the most widely differing methods are usual and known in order to determine which entries 8 are carried in the address conversion buffer 2. Within the framework of the invention it is not of significance whether this selection is carried out by a processor itself, or whether the processor passes this task on to the operating system with the aid of an interrupt request.

According to the prior art, there is no information present outside a processor about the entries in its address conversion buffer. By contrast, according to the invention the table 9 is provided for, in which information is stored for each processor and each memory page 6 as to whether a corresponding entry 3a, 3b exists for a memory page 6 in the address conversion buffer 2a, 2b of the processor. One embodiment of the table 9 is to provide a bit vector for each memory page, of which the number of bits corresponds to the number of processors 1 in the computer system. In the example shown, the bit vectors are allocated to the physical memory pages 6. It is likewise possible for the bit vector to be allocated to the virtual memory pages, which can be advantageous depending on the arrangement of the memory management.

In the event of changes to an entry 8 of the address conversion table 7, according to the invention the bit vector of the corresponding memory page 6 is read in and interrogated bit by bit. If a bit is set, a message about the changes to the entry 8 is sent to the processor 1a, 1b, for which this bit stands, via the bus system 4. In accordance with the message, the processor updates in its address conversion buffer the entry 3a, 3b which relates to this memory page 6. A change can in this case relate to a change in the allocation between the virtual address V and physical address P of a memory page, or to a change in the additional information Z.

At every change to an entry 3a, 3b of an address conversion buffer, it must be guaranteed that the table 9 correctly reflects the contents of the address conversion buffer. If an entry 3a, 3b relating to a memory page 6 is newly deposited in the address conversion buffer of a processor, the corresponding bit is set in the table 9, or reset in the event of the deletion of an entry 3a, 3b. With a computer system in which each processor manages the entries 3a, 3b of its address conversion buffer itself, it is of advantage for the processor concerned also to be designed so as to carry out the updating of the table 9. In the event of the processor forwarding the management of its address conversion buffer to the operating system with the aid of an interruption request, then by analogy the operating system is designed to update the table 9.

In the embodiment represented here, a bit is provided in the table 9 for each memory page 6 and each processor 1a, 1b. With multi-processor computer systems with many processors, the table 9 therefore achieves a not inconsiderable size. If, for example, the size of a memory page is 4 kByte, and if the computer system has 1024 processors, a bit vector is already 128 bytes in size. The table 9 then occupies 4 kByte/28 byte= 1/32, i.e. about 3%, of the main memory. In an advantageous further embodiment of the invention, it is then possible for the processors to be brought together in groups of specified size for the representation in table 9, and in each case for a group to be represented by a bit in the bit vector. The bit is then to be set if at least one of the processors of a group exhibits an entry 3a, 3b for a specific memory page 6. If an entry is deleted in an address conversion buffer of a processor, then, by analogy, the bit can only be reset if none of the other processors of the group exhibits a corresponding entry in its address conversion buffer. In the event of a change which relates to the memory page 6, a message is then sent to all the processors of the group via the bus system 4. This does indeed in turn increase the data traffic on the bus system, but in return the memory requirement of table 9 is reduced by a factor which corresponds to the number of processors in a group.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

I claim:

1. A method for updating entries (3) of address conversion buffers (2) in a multi-processor computer system, wherein each processor (1) exhibits an address conversion buffer (2) and wherein a main memory (5) which is addressed virtually page by page, is provided for, comprising the steps of:
providing entries of the address conversion buffer that comprise a virtual address (V) of a memory page, a physical address (P) of the memory page, and additional information (Z) relating to the memory page;
providing a table in the main memory into which an entry is made for each memory page and each processor as to whether an entry is present for this memory page in the address conversion buffer of the corresponding processor; and
in the event of a change in the additional information (Z) or a change or a new deposition or a deletion of the allocation of a physical address (P) to a virtual address (V) of a memory page, sending a message exclusively to such processors that comprise an entry for the corresponding memory page in their address conversion buffer.

2. The method according to claim 1, wherein, on arrival of a message which relates to change in the additional information (Z) and/or change in the allocation of a physical address (P) to a virtual address (V) of a memory page (6), changing ithe corresponding entry (3) in the address conversion buffer (2) of the processor (1) to which the message is sent accordingly.

3. The method according to claim 1, wherein, on arrival of a message which relates to new deposition of the allocation of a physical address (P) to a virtual address (V) of a memory page, creating a corresponding entry in the address conversion buffer of the processor to which the message is sent, and making a marking in the table that this entry is present.

4. The method according to claim 1, wherein, on arrival of a message which relates to deletion of the allocation of a physical address (P) to a virtual address (V) of a memory page, deleting the corresponding entry in the address conversion buffer of the processor which contains the message, and making a marking in the table that this entry is not present.

5. The method according to claim 1, wherein a bit vector is provided for in the table for each memory page, in which a bit in the bit vector is assigned to each processor, and the bit indicates whether an entry to this memory page is present or not in the address conversion buffer of the corresponding processor.

6. The method according to claim 1, wherein in each case several processors are allocated to a processor group, and a bit vector is provided in the table for each memory page, and a bit in the bit vector is assigned to each processor group, and the bit indicates whether an entry for this memory page is present or not in at least one of the address conversion buffer of the processors which are allocated to the corresponding processor group.

7. A multi-processor computer system with a page-by-page virtually addressable main memory, wherein each processor of the multi-processor computer system exhibits an address conversion buffer,
wherein entries of the address conversion buffer comprise a virtual address (V) of a memory page, a physical address (P) of the memory page, and additional information (Z) relating to the memory page;
a table provided in the main memory, in which an entry is made for each memory page and each processor as to whether an entry for this memory page is present in the address conversion buffer of the corresponding processor; and
an operating system which is adapted such that, in the event of a change to the additional information (Z) or a change or new deposition or deletion of the allocation of a physical address (P) to a virtual address (V) of a memory page, a message is sent exclusively to such processors that comprise an entry for the corresponding memory page in their address conversion buffer.

8. The multi-processor computer system according to claim 7, wherein the processor (1) which receives a message which relates to the change in the additional information (Z), or the change or the new deposition or the deletion of the allocation of a physical address (P) to a virtual address (V) of a memory page, is adapted to change or to create or to delete the corresponding entry in its address conversion buffer, and to mark in the table whether this entry is present in its address conversion buffer.

9. The multi-processor computer system according to claim 7, wherein the processor which receives a message which relates to the change in the additional information (Z), or the change or the new deposition or the deletion of the allocation of a physical address (P) to a virtual address (V) of a memory page (6), is adapted to issue an interrupt request.

10. The multi-processor computer system according to claim 9, wherein the operating system is adapted to receive the interrupt request and to change or create or delete the corresponding entry in the address conversion buffer of the processor which has sent the interrupt request, and to mark in the table whether this entry is present in the address conversion buffer.
